(19) United States
(12) Patent Application Publication
(10) Pub. No.: US 2024/0149513 A1
(43) Pub. Date: May 9, 2024

(54) INJECTION DEVICE

(71) Applicant: FANUC CORPORATION, Minamitsuru-gun, Yamanashi (JP)

(72) Inventors: Takuya OSAWA, Minamitsuru-gun, Yamanashi-ken (JP); Shoutarou SEKIGUCHI, Minamitsuru-gun, Yamanashi-ken (JP)

(21) Appl. No.: 18/273,223

(22) PCT Filed: Jan. 20, 2022
(86) PCT No.: PCT/JP2022/001948

§ 371 Date: Jul. 19, 2023

(30) Foreign Application Priority Data
Jan. 29, 2021 (JP) 2021-013465

(51) Int. Cl. B29C 45/50; B29C 45/76

(52) U.S. Cl. CPC B29C 45/5008; B29C 45/76; B29C 2045/504; B29C 2045/5064; B29C 2945/7602; B29C 2945/76214; B29C 2945/76692

(57) ABSTRACT

An embodiment of the present invention provides an injection device including a screw that includes a plurality of outer circumferential protrusions, each of the plurality of outer circumferential protrusions being provided with an outer circumferential protrusion slope and a second outer circumferential protrusion slope. A bush of the injection device includes a plurality of inner circumferential protrusions, each of the plurality of inner circumferential protrusions being provided with an inner circumferential protrusion slope and a second inner circumferential protrusion slope. A rear end of each of the plurality of outer circumferential protrusions and a front end of each of the plurality of inner circumferential protrusions include no flat surface.

### TECHNICAL FIELD

The present invention relates to an injection device.

### BACKGROUND ART

JP 2019-055488 A discloses a motor control unit that controls a linear motion motor and a rotational motion motor. The linear motion motor is a motor for moving a bush in the axial direction of a screw. The rotational motion motor is a motor for rotating the bush around the axis of the screw.

The motor control unit controls the linear motion motor to move the bush forward in a direction of approaching the screw from a state of being separated from the screw. When the torque of the linear motion motor has become equal to or greater than a first torque during the forward movement of the bush, the motor control unit controls the rotational motion motor to rotate the bush.

### SUMMARY OF THE INVENTION

Incidentally, in order to enhance the working efficiency for spline fitting, there is a demand for spline fitting only by moving the bush forward relative to the screw without rotating the bush.

It is therefore an object of the present invention to provide an injection device capable of enhancing the working efficiency for spline fitting.

According to an aspect of the present invention, there is provided an injection device including a screw disposed along a forward and rearward direction including a forward direction in which an injection resin is injected and a rearward direction opposite to the forward direction, and a bush configured to be spline-fitted to the screw, wherein the screw includes a plurality of outer peripheral projections formed on an outer peripheral surface on a rear end side of the screw, the outer peripheral projections extending along the forward and rearward direction and being formed at intervals in a circumferential direction of the screw, each of the outer peripheral projections is formed with an outer peripheral projection inclined surface and a second outer peripheral projection inclined surface, the outer peripheral projection inclined surface being inclined in a manner so that an outer peripheral projection width along the circumferential direction of the screw becomes smaller toward a rear end of each of the outer peripheral projections, the second outer peripheral projection inclined surface being inclined in a manner so that an outer diameter of the screw becomes smaller toward the rear end of each of the outer peripheral projections, the bush includes a through hole extending in the forward and rearward direction, and a plurality of inner peripheral projections formed on an inner peripheral surface of the through hole, the inner peripheral projections extending in the forward and rearward direction and being formed at intervals in a circumferential direction of the through hole, each of the inner peripheral projections is formed with an inner peripheral projection inclined surface and a second inner peripheral projection inclined surface, the inner peripheral projection inclined surface being inclined in a manner so that an inner peripheral projection width along the circumferential direction of the through hole becomes smaller toward a front end of each of the inner peripheral projections, the second inner peripheral projection inclined surface being inclined in a manner so that an inner diameter of the bush becomes larger toward the front end of each of the inner peripheral projections, and a rear end of each of the outer peripheral projections and a front end of each of the inner peripheral projections include no flat surface.

According to the aspect of the present invention, the spline fitting can be performed by the forward movement of the bush relative to the screw without rotating the bush. As a result, the working efficiency for spline fitting can be enhanced.

### BRIEF DESCRIPTION OF DRAWINGS

FIG. 1 is a schematic view showing an injection device according to an embodiment;

FIG. 2 is a view showing a screw and a bush;

FIG. 3A is a cross sectional view of the screw of FIG. 2;

FIG. 3B shows a cross sectional view of the bush of FIG. 2;

FIG. 4 is a flowchart illustrating a procedure of a control process executed by a motor control unit in order to perform spline-fitting of the screw to the bush; and

FIG. 5 is a view showing a screw and a bush according to a first modification.

### DETAILED DESCRIPTION OF THE INVENTION

Preferred embodiments of the present invention will be described below in detail with reference to the accompanying drawings.

### Embodiment

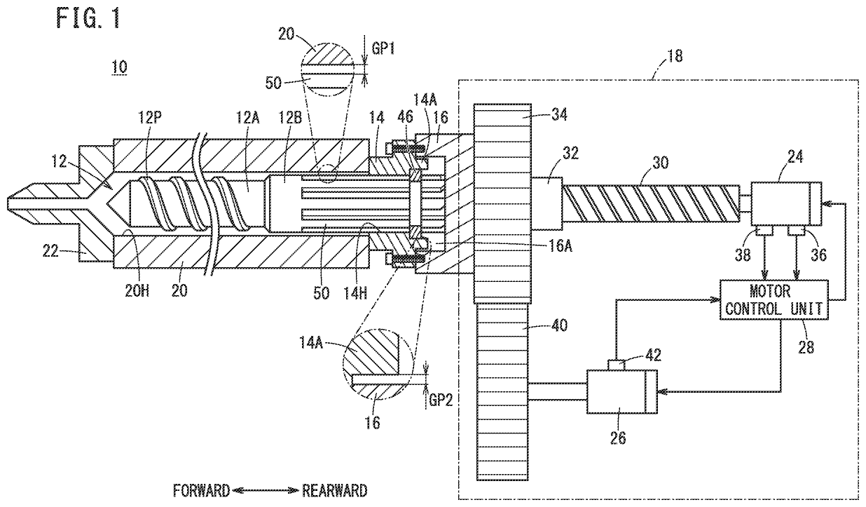

FIG. 1 is a schematic diagram illustrating an injection device 10 according to an embodiment. The injection device 10 injects a molding resin into a mold. In the present embodiment, an injection direction in which the molding resin is injected is a forward direction, and a direction opposite to the injection direction is a rearward direction. The injection device 10 includes a screw 12, a bush 14, a bush fastening portion 16, and a drive mechanism 18.

The screw 12 is accommodated in a through hole 20H of a cylinder 20. The screw 12 rotates to deliver, in the forward direction, the molding resin fed into the through hole 20H. The cylinder 20 includes, at a front end thereof, a nozzle 22, and the molding resin delivered by the screw 12 is injected from the nozzle 22. The screw 12 has a screw portion 12A and a spline portion 12B.

The screw portion 12A is a front portion of the screw 12. A helical protrusion 12P is formed on the outer peripheral surface of the screw portion 12A. The spline portion 12B is a rear portion of the screw 12 and is connected to a rear end of the screw portion 12A. The outer peripheral surface of the spline portion 12B is formed with concavities and convexities that can be spline-fitted to the bush 14.

The bush 14 is spline-fitted to the screw 12. The bush 14 has a through hole 14H extending therethrough in the forward and rearward direction. The inner peripheral surface of the through hole 14H is formed with concavities and convexities that can be spline-fitted to the spline portion 12B. The bush 14 is provided with an annular protrusion 14A protruding rearward from the rear end surface of the bush 14.

The bush fastening portion 16 fixes the bush 14 at the rear of the bush 14. The bush fastening portion 16 has a recess 16A in which the protrusion 14A of the bush 14 is accommodated. The bush 14 is fixed to the bush fastening portion 16 by using bolts, and the protrusion 14A is housed in the recess 16A.

The drive mechanism 18 is a mechanism that drives at least one of the screw 12 or the bush 14 so as to move the bush 14 relative to the screw 12. In the present embodiment, the drive mechanism 18 drives the bush 14. The drive mechanism 18 includes a linear motion motor 24, a rotary motor 26, and a motor control unit 28.

The linear motion motor 24 is a motor that moves the bush 14 forward and rearward in the forward and rearward direction. A ball screw 30 is coupled to the motor shaft of the linear motion motor 24, and rotates together with the motor shaft. A sliding portion 32 is attached to the ball screw 30 such that the ball screw 30 can move forward and rearward in the forward and rearward direction in accordance with the rotation of the linear motion motor 24. A linear motion gear 34 is rotatably attached to the sliding portion 32. The linear motion gear 34 is fixed to the rear end of the bush fastening portion 16. The linear motion motor 24 is provided with an encoder 36 that detects a rotation angle of the linear motion motor 24 and a detection unit 38 that detects a linear motion torque of the linear motion motor 24.

The rotary motor 26 is a motor that rotates the bush 14. A rotation gear 40 meshing with the linear motion gear 34 is coupled to the motor shaft of the rotary motor 26. The rotary motor 26 is provided with an encoder 42 for detecting a rotation angle of the rotary motor 26.

In the drive mechanism 18, when the linear motion motor 24 rotates, the linear motion gear 34 moves in the forward and rearward direction via the ball screw 30 and the sliding portion 32 in accordance with the rotation of the linear motion motor 24. In this case, the rotation gear 40 meshing with the linear motion gear 34 and the rotary motor 26 move in the forward and rearward direction, and the bush 14 moves in the forward and rearward direction via the bush fastening portion 16 to which the linear motion gear 34 is fixed. On the other hand, when the rotary motor 26 rotates, the rotation gear 40 rotates in accordance with the rotation of the rotary motor 26. In this case, the linear motion gear 34 meshing with the rotation gear 40 rotates, and the bush 14 rotates via the bush fastening portion 16 to which the linear motion gear 34 is fixed.

The motor control unit 28 controls the linear motion motor 24 such that the rotation angle detected by the encoder 36 becomes a target value, thereby moving the bush 14 forward and rearward. The motor control unit 28 rotates the bush 14 by controlling the rotary motor 26 such that the rotation angle detected by the encoder 42 becomes a target value.

The motor control unit 28 executes the control process for controlling only the linear motion motor 24 while monitoring the linear motion torque detected by the detection unit 38, thereby causing the screw 12 and the bush 14 to be spline-fitted to each other.

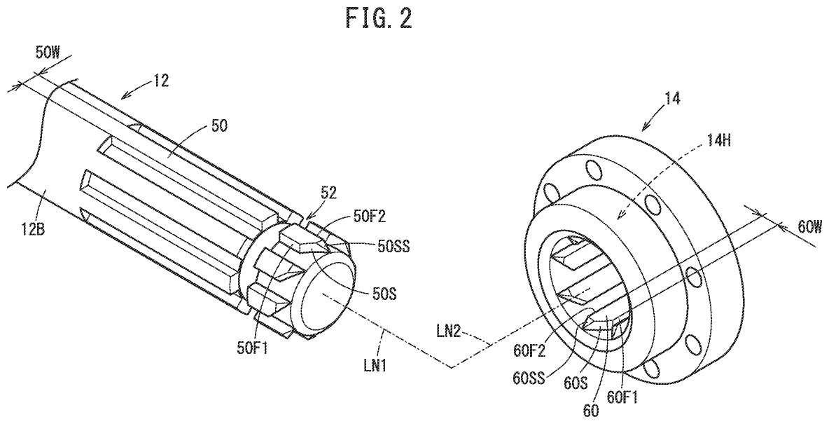

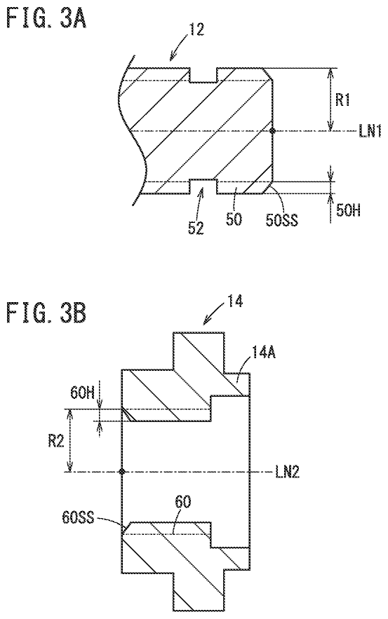

FIG. 2 is a view showing the screw 12 and the bush 14, FIG. 3A is a cross sectional view of the screw 12 of FIG. 2, and FIG. 3B is a cross sectional view of the bush 14 of FIG. 2.

The spline portion 12B includes a plurality of outer peripheral projections 50 formed on an outer peripheral surface of the spline portion. The projections 50 extend along the forward and rearward direction and are formed at intervals in the circumferential direction of the spline portion 12B. Each of the outer peripheral projections 50 is divided by a fitting groove 52 which extends along and around the circumferential direction of the spline portion 12B. An annular retainer 46 (FIG. 1) is fitted into the fitting groove 52.

The outer peripheral projections 50 have the same shape. Hereinafter, the shape of only one of the outer peripheral projections 50 will be described. The rear end of the outer peripheral projection 50 is formed in a pointed shape or a rounded shape. That is, the rear end of the outer peripheral projection 50 of the screw 12 has no flat surface. In addition, there is no plane orthogonal to the rotation center line LN1 (FIG. 2) of the screw 12 at the rearmost end of the screw 12. At the rear end portion of the outer peripheral projection 50, an outer peripheral projection inclined surface 50S and a second outer peripheral projection inclined surface 50SS are formed so as to extend toward the rear end of the outer peripheral projection 50.

The outer peripheral projection inclined surface 50S is formed on one of both side surfaces 50F1 and 50F2 of the outer peripheral projection 50 in the circumferential direction of the screw 12. The outer peripheral projection inclined surface 50S is inclined such that an outer peripheral projection width 50W along the circumferential direction of the screw 12 becomes smaller toward the rear end.

The second outer peripheral projection inclined surface 50SS is inclined such that the outer diameter of the screw 12 gradually decreases toward the rear end of the outer peripheral projection 50. That is, the second outer peripheral projection inclined surface 50SS is inclined such that the radius R1 (FIG. 3A) of the screw 12 from the rotation center line LN1 of the screw 12 gradually decreases toward the rear end of the outer peripheral projection 50.

The through hole 14H of the bush 14 includes a plurality of inner peripheral projections 60 formed on an inner peripheral surface of the through hole 14H. The inner peripheral projections extend along the forward and rearward direction and are formed at intervals in the circumferential direction of the through hole 14H. The inner peripheral projections 60 have the same shape. Hereinafter, the shape of only one of the inner peripheral projections 60 will be described. The front end of the inner peripheral projection 60 is formed in a pointed shape or a rounded shape. That is, there is no flat surface at the front end of the inner peripheral projection 60 of the bush 14. In addition, there is no plane orthogonal to the center line LN2 (FIG. 2) of the through hole 14H of the bush 14 at the foremost end of the bush 14. At the front end portion of the inner peripheral projection 60, an inner peripheral projection inclined surface 60S and a second inner peripheral projection inclined surface 60SS are formed so as to extend toward the front end of the inner peripheral projection 60.

The inner peripheral projection inclined surface 60S is formed on one of both side surfaces 60F1 and 60F2 of the inner peripheral projection 60 in the circumferential direction of the through hole 14H. The inner peripheral projection inclined surface 60S is inclined such that an inner peripheral projection width 60W along the circumferential direction of the through hole 14H becomes smaller toward the front end.

The second inner peripheral projection inclined surface 60SS is inclined such that the diameter of the through hole 14H of the bush 14 gradually increases toward the front end of the inner peripheral projection 60. In other words, the second inner peripheral projection inclined surface 60SS is inclined such that the radius R2 (FIG. 3B) of the through hole 14H from the center line LN2 of the through hole 14H gradually increases toward the front end of the inner peripheral projection 60.

Meanwhile, in the injection device 10, a relationship of the following Inequality (1) is satisfied. In Inequality (1), Cs1 is a height 50H (FIG. 3A) of the second outer peripheral projection inclined surface 50SS. In Inequality (1), Cb1 is a height 60H (FIG. 3B) of the second inner peripheral projection inclined surface 60SS. In Inequality (1), Ls1 is a gap GP1 (FIG. 1) between the outer peripheral projection 50 and the cylinder 20 when the screw 12 fitted to the bush 14 is housed in the cylinder 20. In Inequality (1), Lb1 is a gap GP2 (FIG. 1) between the outer periphery of the protrusion 14A of the bush 14 and the inner periphery of the recess 16A of the bush fastening portion 16 when the bush 14 is fixed to the bush fastening portion 16.

Cs1+Cb1>Ls1+Lb1 (1)

The height 50H (FIG. 3A) of the second outer peripheral projection inclined surface 50SS is a distance (projection distance), in the radial direction of the screw 12, between the most projecting position of the outer peripheral projection inclined surface 50S and the rear end of the outer peripheral projection inclined surface 50S. The height 60H (FIG. 3B) of the second inner peripheral projection inclined surface 60SS is a distance (projection distance), in the radial direction of the bush 14, between the most projecting position of the inner peripheral projection inclined surface 60S and the front end of the inner peripheral projection inclined surface 60S.

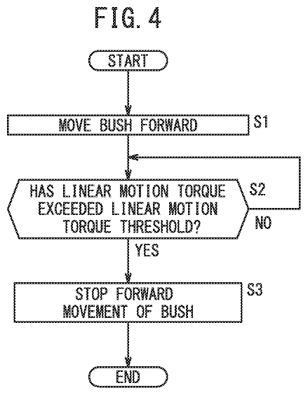

FIG. 4 is a flowchart illustrating a procedure of the control process executed by the motor control unit 28 in order to spline-fit the screw 12 to the bush 14. This control process is started after the bush 14 has been moved to a predetermined fitting start position spaced apart from the rear end surface of the screw 12 in the rearward direction. At the fitting start position, the rotation center line LN1 (FIG. 2) of the screw 12 and the center line LN2 (FIG. 2) of the through hole 14H of the bush 14 need not necessarily coincide with each other as long as Inequality (1) is satisfied.

In step S1, the motor control unit 28 moves the bush 14 forward toward the screw 12. When the forward movement of the bush 14 is started, the control process proceeds to step S2.

In step S2, the motor control unit 28 compares the linear motion torque detected by the detection unit 38 during the forward movement of the bush 14 with the linear motion torque threshold. If the linear motion torque does not exceed the linear motion torque threshold, the control process remains at step S2. On the other hand, when the linear motion torque exceeds the linear motion torque threshold, the control process proceeds to step S3.

The situation in which the linear motion torque exceeds the linear motion torque threshold occurs in the state where the rear end surface of the screw 12 spline-fitted to the bush 14 is in contact with the bottom surface of the recess 16A of the bush fastening portion 16.

In step S3, the motor control unit 28 stops the forward movement of the bush 14 when the linear motion torque exceeds the linear motion torque threshold. When the forward movement of the bush 14 is stopped, the control process ends.

As described above, the outer peripheral projection 50 of the screw 12 is formed with the outer peripheral projection inclined surface 50S and the second outer peripheral projection inclined surface 50SS, and the outer peripheral projection 50 has no flat surface at the rear end. On the other hand, the inner peripheral projection 60 of the bush 14 is formed with the inner peripheral projection inclined surface 60S and the second inner peripheral projection inclined surface 60SS, and the inner peripheral projection 60 has no flat surface at the front end. Therefore, the spline fitting can be performed by the forward movement of the bush 14 relative to the screw 12 without rotating the bush 14, and as a result, the working efficiency for the spline fitting can be enhanced.

In addition, in the injection device 10, the relationship of the above inequality (1) is satisfied. Accordingly, spline fitting can be performed by the forward movement of the bush 14 relative to the screw 12 without rotating the bush 14, while considering the cylinder 20 in which the screw 12 is accommodated and the bush fastening portion 16 to which the bush 14 is fixed.

In addition, the injection device 10 includes the motor control unit 28 that controls the linear motion motor 24. The motor control unit 28 moves the bush 14 forward from a position spaced from the screw 12, and stops the movement of the bush 14 when the linear motion torque exceeds the linear motion torque threshold. Thus, the spline fitting can be automated, and as a result, variation in time required for operation of the spline fitting due to the level of skill of the worker can be reduced.

### [Modifications]

The above embodiment may be modified as follows.

### (Modification 1)

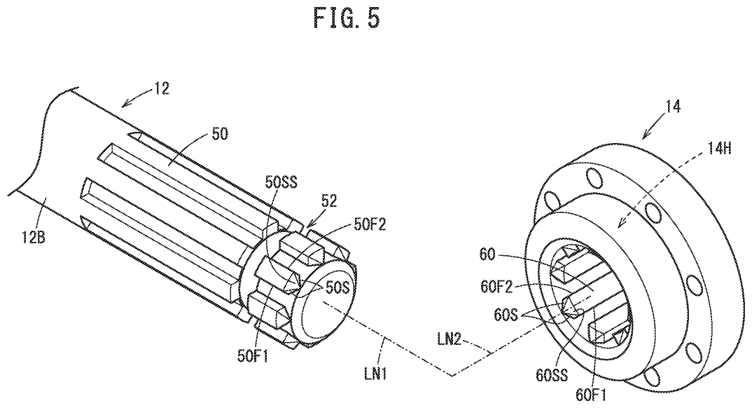

FIG. 5 is a view showing a screw 12 and a bush 14 according to a first modification. In FIG. 5, the same reference numerals are used to designate constituent elements that are the same as those described in the embodiment. Moreover, in the present modification, descriptions that overlap or are duplicative of those stated in the embodiment will be omitted.

In the present modification, the outer peripheral projection inclined surface 50S of the outer peripheral projection 50 is formed on each of both side surfaces 50F1 and 50F2 in the circumferential direction of the screw 12. In addition, the inner peripheral projection inclined surface 60S of the inner peripheral projection 60 is formed on each of both side surfaces 60F1 and 60F2 in the circumferential direction of the through hole 14H. Even with this configuration, as in the embodiment, spline fitting can be performed by the forward movement of the bush 14 relative to the screw 12 without rotating the bush 14.

### (Modification 2)

The second outer peripheral projection inclined surface 50SS may be formed not only on each of the outer peripheral projections 50 but also between the outer peripheral projections 50, as in the first modification. With this configuration, even if the center line LN2 of the through hole 14H of the bush 14 is displaced in the radial direction of the screw 12 with respect to the rotation center line LN1 of the screw 12, spline fitting can be performed by moving the bush 14 forward toward the screw 12.

### (Modification 3)

The rear end of the outer peripheral projection 50 may be located on the same plane as the rear end surface of the screw 12 or may be located forward of the rear end surface of the screw 12. That is, the rear end of the outer peripheral projection 50 in the embodiment may be located forward of the rear end surface of the screw 12. In addition, the rear end of the outer peripheral projection 50 in the first modification may be positioned on the same plane as the rear end surface of the screw 12.

The front end of the inner peripheral projection 60 may be located on the same plane as the front end surface of the bush 14 or may be located rearward of the front end surface of the bush 14. That is, the front end of the inner peripheral projection 60 in the embodiment may be located rearward of the front end surface of the bush 14. Further, the front end of the inner peripheral projection 60 in the first modification may be located on the same plane as the front end surface of the bush 14.

### (Modification 4)

The above-described embodiment and the modifications thereof may be optionally combined within a range in which no technical inconsistencies occur.

The above is summarized as follows.

The present invention is characterized by the injection device (10) including the screw (12) disposed along the forward and rearward direction including the forward direction in which an injection resin is injected and the rearward direction opposite to the forward direction, and the bush (14) configured to be spline-fitted to the screw, wherein the screw includes the outer peripheral projections (50) formed on the outer peripheral surface on the rear end side of the screw, the outer peripheral projections extending along the forward and rearward direction and being formed at intervals in the circumferential direction of the screw, each of the outer peripheral projections is formed with the outer peripheral projection inclined surface (50S) and the second outer peripheral projection inclined surface (50SS), the outer peripheral projection inclined surface being inclined in a manner so that the outer peripheral projection width (50W) along the circumferential direction of the screw becomes smaller toward the rear end of each of the outer peripheral projections, the second outer peripheral projection inclined surface being inclined in a manner so that the outer diameter of the screw becomes smaller toward the rear end of each of the outer peripheral projections, the bush includes the through hole (14H) extending in the forward and rearward direction, and the inner peripheral projections (60) formed on the inner peripheral surface of the through hole, the inner peripheral projections extending in the forward and rearward direction and being formed at intervals in the circumferential direction of the through hole, each of the inner peripheral projections is formed with the inner peripheral projection inclined surface (60S) and the second inner peripheral projection inclined surface (60SS), the inner peripheral projection inclined surface being inclined in a manner so that the inner peripheral projection width (60W) along the circumferential direction of the through hole becomes smaller toward the front end of each of the inner peripheral projections, the second inner peripheral projection inclined surface being inclined in a manner so that the inner diameter of the bush becomes larger toward the front end of each of the inner peripheral projections, and the rear end of each of the outer peripheral projections and the front end of each of the inner peripheral projections include no flat surface.

With this configuration, the spline fitting can be performed by the forward movement of the bush relative to the screw without rotating the bush. As a result, the working efficiency for spline fitting can be enhanced.

The outer peripheral projection inclined surface may be formed on one of both side surfaces (50F1, 50F2), in the circumferential direction of the screw, of the rear end side of each of the outer peripheral projections, and the inner peripheral projection inclined surface may be formed on one of both side surfaces (60F1, 60F2), in the circumferential direction of the through hole, of the front end side of each of the inner peripheral projections.

With this configuration, the spline fitting can be performed by the forward movement of the bush relative to the screw without rotating the bush.

The outer peripheral projection inclined surface may be formed on each of both side surfaces, in the circumferential direction of the screw, of the rear end side of each of the outer peripheral projections, and the inner peripheral projection inclined surface may be formed on each of both side surfaces, in the circumferential direction of the through hole, of the front end side of each of the inner peripheral projections.

With this configuration, the spline fitting can be performed by the forward movement of the bush relative to the screw without rotating the bush.

The bush may be provided with the protrusion (14A) protruding from the rear end surface of the bush. The injection device may further include: the bush fastening portion (16) including the recess (16A) in which the protrusion is accommodated, the bush fastening portion being configured to fix the bush in a manner so that the protrusion is accommodated in the recess; and the cylinder (20) in which the screw is accommodated. When the height (50H) of the second outer peripheral projection inclined surface is defined as Cs1, the height (60H) of the second inner peripheral projection inclined surface is defined as Cb1, the gap (GP1) between the outer peripheral projections and the cylinder when the screw fitted to the bush is accommodated in the cylinder is defined as Ls1, and the gap (GP2) between the outer periphery of the protrusion and the inner periphery of the recess when the bush is fixed to the bush fastening portion is defined as Lb1, the relationship of Cs1+Cb1>Ls1+Lb1 may be satisfied.

With this configuration, spline fitting can be performed by the forward movement of the bush relative to the screw without rotating the bush, while considering the cylinder in which the screw is accommodated and the bush fastening portion to which the bush is fixed.

The injection device may further include: the linear motion motor (24) configured to move the bush forward and rearward in the forward and rearward direction with respect to the screw; the detection unit (38) configured to detect the linear motion torque of the linear motion motor; and the motor control unit (28) configured to control the linear motion motor to move the bush forward from a position away from the screw and to stop the bush when the linear motion torque exceeds the linear motion torque threshold.

Thus, the spline fitting can be automated. As a result, variation in time required for operation of the spline fitting due to the level of skill of the worker can be reduced.

1. An injection device comprising a screw disposed along a forward and rearward direction including a forward direction in which an injection resin is injected and a rearward direction opposite to the forward direction, and a bush configured to be spline-fitted to the screw, wherein
the screw includes a plurality of outer peripheral projections formed on an outer peripheral surface on a rear end side of the screw, the outer peripheral projections extending along the forward and rearward direction and being formed at intervals in a circumferential direction of the screw,
each of the outer peripheral projections is formed with an outer peripheral projection inclined surface and a second outer peripheral projection inclined surface, the outer peripheral projection inclined surface being inclined in a manner so that an outer peripheral projection width along the circumferential direction of the screw becomes smaller toward a rear end of each of the outer peripheral projections, the second outer peripheral projection inclined surface being inclined in a manner so that an outer diameter of the screw becomes smaller toward the rear end of each of the outer peripheral projections,
the bush includes a through hole extending in the forward and rearward direction, and a plurality of inner peripheral projections formed on an inner peripheral surface of the through hole, the inner peripheral projections extending in the forward and rearward direction and being formed at intervals in a circumferential direction of the through hole,
each of the inner peripheral projections is formed with an inner peripheral projection inclined surface and a second inner peripheral projection inclined surface, the inner peripheral projection inclined surface being inclined in a manner so that an inner peripheral projection width along the circumferential direction of the through hole becomes smaller toward a front end of each of the inner peripheral projections, the second inner peripheral projection inclined surface being inclined in a manner so that an inner diameter of the bush becomes larger toward the front end of each of the inner peripheral projections, and
a rear end of each of the outer peripheral projections and a front end of each of the inner peripheral projections include no flat surface.

2. The injection device according to claim 1, wherein
the outer peripheral projection inclined surface is formed on one of both side surfaces, in the circumferential direction of the screw, of a rear end side of each of the outer peripheral projections, and
the inner peripheral projection inclined surface is formed on one of both side surfaces, in the circumferential direction of the through hole, of a front end side of each of the inner peripheral projections.

3. The injection device according to claim 1, wherein
the outer peripheral projection inclined surface is formed on each of both side surfaces, in the circumferential direction of the screw, of a rear end side of each of the outer peripheral projections, and
the inner peripheral projection inclined surface is formed on each of both side surfaces, in the circumferential direction of the through hole, of a front end side of each of the inner peripheral projections.

4. The injection device according to claim 1,
wherein the bush is provided with a protrusion protruding from a rear end surface of the bush,
wherein the injection device further comprises:
a bush fastening portion including a recess in which the protrusion is accommodated, the bush fastening portion being configured to fix the bush in a manner so that the protrusion is accommodated in the recess; and
a cylinder in which the screw is accommodated, and
wherein
when a height of the second outer peripheral projection inclined surface is defined as Cs1, a height of the second inner peripheral projection inclined surface is defined as Cb1, a gap between the outer peripheral projections and the cylinder when the screw fitted to the bush is accommodated in the cylinder is defined as Ls1, and a gap between an outer periphery of the protrusion and an inner periphery of the recess when the bush is fixed to the bush fastening portion is defined as Lb1,
a relationship of Cs1+Cb1>Ls1+Lb1 is satisfied.

5. The injection device according to claim 1, further comprising:
a linear motion motor configured to move the bush forward and rearward in the forward and rearward direction with respect to the screw;
a detection unit configured to detect a linear motion torque of the linear motion motor; and
a motor control unit configured to control the linear motion motor to move the bush forward from a position away from the screw and to stop the bush when the linear motion torque exceeds a linear motion torque threshold.
